(19) United States
(12) Patent Application Publication
(10) Pub. No.: US 2004/0009732 A1
(43) Pub. Date: Jan. 15, 2004

(54) Nonwoven ream wrap

(76) Inventor: Michael R. Nowak, Hilbert, WI (US)

Correspondence Address: Philip M. Weiss, WEISS & WEISS, 500 OLD COUNTRY ROAD, GARDEN CITY, NY, 11530, US

(21) Appl. No.: 10/193,478

(22) Filed: Jul. 11, 2002

(51) Int. Cl. B65B 1/00; B65C 1/00; B31B 1/60; B32B 31/00; B32B 5/02; B32B 27/04; B32B 27/12; D04H 3/16; B32B 29/02

(52) U.S. Cl. 442/412; 442/149; 442/401; 156/60

(57) ABSTRACT

A composite ream wrap material comprising paper and non-woven materials, and methods for making such composite wrap material. More particularly, the present invention relates to a composite paper/non-woven structure that is used for packaging paper products, and the process for making such composite wrap material.

### FIELD OF THE INVENTION

The present invention relates to a composite ream wrap material comprising paper and nonwoven materials, and methods for making such composite wrap material. More particularly, the present invention relates to a composite paper/non-woven structure that is used for packaging paper products, and the process for making such composite wrap material.

### BACKGROUND OF THE INVENTION

Reams (i.e., 500 sheets) of cut paper (3-½ X11 , etc.) for copy machines, computers, printers, and other applications are most commonly packaged for shipping, storage, and retail sale in ream wrap made of various wrap materials. These wrap materials traditionally have been paper (poly coated or two papers laminated with poly), plastic film, or a paper/solid plastic film combination. In addition to encasing the reams of paper, the wrap materials protect the wrapped paper product from physical damage and moisture pickup during shipping and storing. The wrap materials also protect the wrapped paper products from physical damage during repeated handling and stocking on retail shelves.

As small offices and home offices have proliferated, the distribution of reams of papers has changed from boxes for large users to wrapped reams for retail stores and the small office and home office segments. Retail and in-store distribution of paper reams has placed increasing demands on the ream wrapper due to rougher handling and more frequent re-stocking of the individual reams. Increased handling of the reams has resulted in more reams breaking open, damaging the wrapped paper product by allowing it to pick up moisture, tear, or get minor curl-physical damage that ultimately results in jams in the end-user's printer or copy machine. As a result the market has demanded a stronger ream wrap. Machine direction and cross direction tear strength properties are a measure of the overall strength of the wrapper and its ability to resist breaking open.

The market also has required that ream wraps be made of materials that have an improved printing surface to enhance graphics and provide an eye-appealing wrapped product for the consumer. To this end, ream wrap manufacturers have begun using either films or lighter weight papers that are clay coated and/or have clay in the paper fibers to enhance print surfaces. While the printing surfaces of paper ream wraps have improved, these wrappers have become easier to tear and provide less structural protection for the wrapped paper products.

Similarly, a major disadvantage of the film ream wrappers is that they tear easily, provide minimal structural support, and result in physical damage to the wrapped paper products. Another disadvantage of film wrappers is that, due to their stretch properties, they are difficult to run on equipment designed to wrap paper, necessitating costly modifications to paper packaging lines.

U.S. Pat. No. 4,808,467 relates to a high strength hydroentangled nonwoven fabric. A strong, absorbent nonwoven fabric containing wood pulp and textile fibers is prepared by hydro entanglement with a continuous filament, base web. The fabric may be apertured or essentially nonapertured and may be made water repellant for use in medical and surgical applications.

U.S. Pat. No. 4,879,170 relates to a nonwoven fibrous hydraulically entangled elastic coform material and method of formation thereof. The elastomeric web material is a hydraulically entangled coform or admixture of meltblown fibers, such as elastic meltblown fibers and pulp fibers and/or meltblown fibers and/or continuous filaments, with or without particulate material; such coform can be hydraulically entangled by itself or with other materials, including, super absorbent particulate material. The fiber material can be pulp fiber. The fiber material can be any cellulosic material, including wood fibers, rayon, cotton; and the staple can be natural or synthetic fibers including wool fibers and polyester fibers.

U.S. Pat. No. 5,593,768 relates to nonwoven fabric laminates comprising a thermally bonded multiconstituent fiber nonwoven web. The multiconstituent fiber is composed of a highly dispersed blend of at least two different thermoplastic polymers which are present as a dominant continuous phase and at least one noncontinuous phase dispersed therein. The noncontinuous phase exists as an elongated fibrillar polymer domain oriented generally in the direction of the fiber access. The fabric laminate also comprises at least one other web bonded to the multiconstituent fibers of the thermally bonded nonwoven web and a multiplicity of thermal bonds formed from the polymer of said multicontituent fibers and bonding the multiconstituent fibers of said thermally bonded web to said at least one other web.

Nonwoven fabrics and fabric laminates are widely used in a variety of every day applications as components in absorbent products such as disposable diapers, adult incontinence pads and sanitary napkins; in medical applications such as surgical gowns, surgical drapes, sterilization wraps; and for disposable wipes, industrial garments, house wrap, carpets and filtration media.

Laminates may be made by combining nonwoven fabrics made from the multiconsituent fiber with films, paper tissue, woven fabrics, or nonwoven fabrics, including meltblown nonwovens. Such laminates are suitable for use in filtration media, medical and clean room garments, CSR wrap, absorbent article backsheets, and other barrier structures.

U.S. Pat. No. 6,133,168 relates to a coated substrate having a MVTR greater than about 5 perms comprising a substrate, a monolithic, extrusion coated breathable polymer layer, and a primer layer intermediate and adhered to the substrate and the monolithic, extrusion coated breathable polymer layer.

The substrate may be any substrate conventionally used in the construction industry for making flexible wraps or rigid panels designed to prevent the passage of air and water. Suitable substrates include, but are not necessarily limited to, non-woven fabrics, paperboard, chipboard, kraft paper, veneers, wood or cellulose composites, natural or synthetic films, foils, glass fiber mats, woven fabrics, and the like, as well as multi-layered laminated structures comprising same. Laminates of these materials are well-known in the construction industry as substrates useful for the manufacture of building wraps, exterior and interior wall panels, floor components, roof underlayments, etc.

### SUMMARY OF THE INVENTION

The present invention relates to a novel composite ream wrap material comprising: a first layer comprised of plain or coated paper; a second layer comprised of a polymer resin or adhesive material; and a third layer comprised of nonwoven material, resulting in either a paper/poly/nonwoven structure whereby the paper and nonwoven material are laminated together with the polymer resin, or a paper/adhesive/nonwoven structure whereby the paper and nonwoven material are adhered with an adhesive.

An object of the present invention is to increase the tear strength of the paper ream wrap. An object of the present invention also is to improve the structural support for the paper products encased in the ream wrap. Another object of the present invention is for the paper layer to provide an enhanced printing surface, improved graphics, and shelf-appeal for the wrapped paper products.

The composite paper/nonwoven wrap material can be prepared by laminating a three-layer structure comprising the layer of paper, an adhesive or poly layer and a nonwoven layer using a nip roller apparatus or other suitable laminating device. The paper and nonwoven layer with the adhesive or poly layer therein between can be passed through a pair of nip rollers to bond the two layers together.

### BRIEF DESCRIPTION OF THE DRAWINGS

Throughout the following views, reference numerals will be used in the drawings, and the same reference numerals will be used throughout the several views and in the description to indicate same or like parts of the invention.

FIG. 1 is a cross-sectional view of a composite wrap material according to the invention.

FIG. 2 is a schematic view of an apparatus used to produce the composite wrap material of FIG. 1.

### DETAILED DESCRIPTION OF THE INVENTION

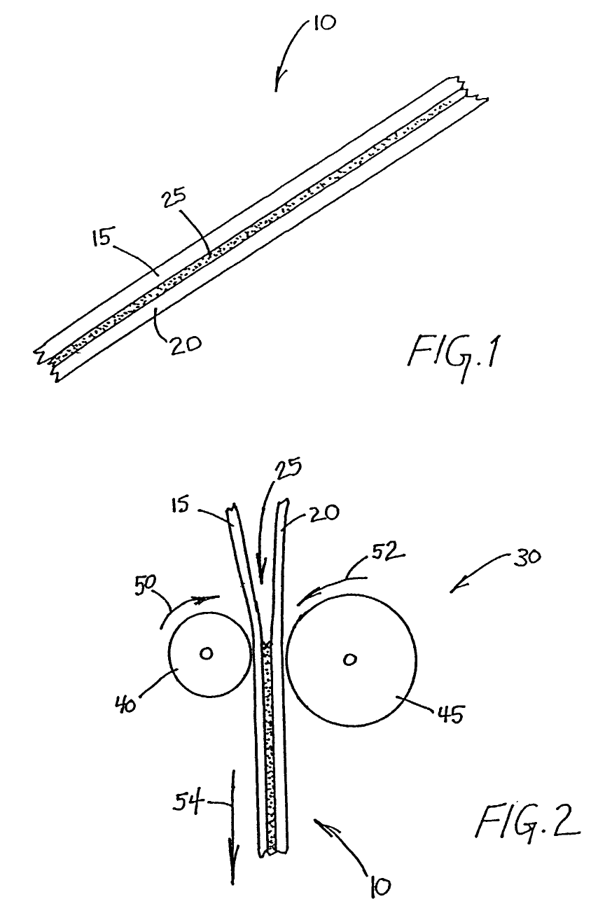

Referring now to the drawings, an embodiment of a composite wrap material according to the invention, generally designated with the numeral 10 is shown in cross-section in FIG. 1.

The composite wrap material 10 is made of a first layer 15 comprising a cellulosic material, a second layer 20 comprising a non-woven material, and an adhesive or polymer layer 25 positioned between the first and second layers. The present invention composite wrap material has an increased strength compared to conventional wrap materials and is particularly effective in maintaining the integrity of a ream of paper packaged within the wrap material during handling.

The first layer 15 of the wrap material 10 can be any material composed primarily of cellulosic fibers. Suitable materials for use as the first layer 15 include, for example, machine-finished or machine-glazed paper, tissue paper, nonwoven tissue paper, air laid fabric, wet-laid fabric, and wet or dry creped tissue, or other types of paper.

The adhesive or polymer layer 25 is interposed between the first and second layers 15, 20. The adhesive or poly is typically in the form of a liquid or flowable material. Examples include wax/polymer blends, polyethylene, polypropylene, polyvinylidene chloride, polyethylene acrylic acid, polyester, polyisobutylene, nylon, polymethylpentene, ethylene vinyl acetate and copolymers thereof. Also useful are hot-melt adhesives, and wax/polymer blends. Such adhesive materials are further described in The Handbook of Adhesives, I. Skeist (ed.) 2d Edition, Van Nostrand Reinhold Company, New York (1977), and Adhesives Handbook, J. Shields, Newnes-Butterworths, London (1976).

The composite wrap material 10 can be prepared for example, by extrusion lamination as schematically depicted in FIG. 2. The laminating device 30 includes two nip rollers 40, 45 that rotate in opposite directions as shown by arrows 50, 52. Prior to passing through the nip rollers 40, 45, the paper layer 15 and nonwoven layer 20 are directed into an adjacent, non-contact position using known techniques. The adhesive or poly material 25 is applied to the paper layer 15 and/or the nonwoven layer 20 in close proximity to the nip rollers. Preferably, the adhesive or poly material 25 initially contacts one of the layers 15, 20 prior to passing into the nip rollers. As the layers 15, 20, 25 pass through the nip rollers 40, 45 in the direction of arrow 54, the three layers contact for the first time to form a three-layered wrap material 10.

The temperature of the rollers 40, 45 can be varied according to the processing temperature of the adhesive material and the processing contact time. One or both of the rollers 40, 45 can be maintained at a temperature to cool and set the adhesive 25 as required. In a typical set-up the surface temperature of the roller 45 is controlled for cooling the adhesive. In passing the two layers 15, 20 and the adhesive or poly layer 25 through the laminating device 30, either the paper layer 15 or the nonwoven layer 20 can be placed in direct contact with the chilled roller.

In an embodiment, a ream wrapper comprises a first layer composed of plain or coated cellulosic material having a basis weight of about 20 to 70 pounds/3,000 sq. ft. A second layer is composed of about 5 to 20 pounds of a polymer resin material or about 0.5 to 5 pounds of adhesive material. A third layer is composed of nonwoven material. The polymer resin or the adhesive is used to laminate or adhere the first and third layers.

The present invention also relates to a method for laminating or adhering the first paper layer and the third nonwoven layer with a polymer resin or an adhesive.

In one embodiment of the present invention, the plain or coated paper substrate is laminated or adhered to the nonwoven material using about 5 to 20 pounds of a polymer resin material or about 0.5 to 5 pounds of an adhesive material. The nonwoven material can comprise about 0.2 to 5 ounces/sq. yard of spunbond nonwoven polyethylene. The final paper/poly/nonwoven or paper/adhesive/nonwoven structure may or may not be printed on the paper side.

In a further embodiment, the plain or coated paper substrate is laminated or adhered to any nonwoven material using about 5 to 20 pounds of a polymer resin material or about 0.5 to 5 pounds of an adhesive material. The final paper/poly/nonwoven or paper/adhesive/nonwoven structure can have printing on the paper side.

In a preferred embodiment, the poly flows through the holes in the nonwoven material creating a tight bond between the paper layer and the nonwoven material. The nonwoven material should be placed on the inside of the ream wrap facing the paper to be wrapped.

1. A ream wrapper comprising;
paper;
a non woven material; and
a poly or adhesive between said paper and said non woven material.

2. The ream wrapper of claim 1 wherein said paper is coated.

3. The ream wrapper of claim 1 wherein said paper is plain.

4. The ream wrapper of claim 1 wherein said paper is laminated to said nonwoven material.

5. The ream wrapper of claim 1 wherein said paper is adhered to said nonwoven material.

6. The ream wrapper of claim 1 wherein said paper has a basis weight of about 20 to 70 pounds/3,000 sq. feet.

7. The ream wrapper of claim 1 wherein said poly comprises about 5 to 20 pounds of a polymer resin.

8. The ream wrapper of claim 1 wherein said adhesive is about 0.5 to 5 pounds of an adhesive material.

9. The ream wrapper of claim 1 wherein said paper is printed.

10. The ream wrapper of claim 1 wherein said paper is not printed.

11. The ream wrapper of claim 1 wherein said nonwoven material comprises about 0.2 to 5 ounces/sq. yard of spunbond nonwoven polyethylene.

12. The ream wrapper of claim 1 wherein said paper is composed primarily of cellulosic fibers.

13. The ream wrapper of claim 1 wherein said paper is selected from the group consisting of machine-finished or machine-glazed paper, tissue paper, nonwoven tissue paper, air laid fabric, wet-laid fabric, and wet or dry creped tissue, or other types of paper.

14. The ream wrapper of claim 1 wherein said adhesive or poly is in the form of a liquid or flowable material.

15. The ream wrapper of claim 1 wherein said adhesive is selected from the group consisting of wax/polymer blends, polyethylene, polypropylene, polyvinylidene chloride, polyethylene acrylic acid, polyester, polyisobutylene, nylon, polymethylpentene, ethylene vinyl acetate and copolymers thereof.

16. A method for making a composite wrap material comprising;
providing a first sheet of a cellulosic material, a second sheet of nonwoven material and an adhesive material;
applying said adhesive to a surface of said first sheet, said second sheet or both;
conveying said first and second sheets into a laminating apparatus with said adhesive material interposed between said first and second sheets;
laminating said two sheets to bond said first and second layers together;
forming an integral wrap material.
